(19) United States
(12) Patent Application Publication
(10) Pub. No.: US 2007/0017131 A1
(43) Pub. Date: Jan. 25, 2007

(54) Real estate sign light

(76) Inventors: Robert J. Visotcky, Carlsbad, CA (US); William P. Conley, Encinitas, CA (US); Rodger D. Thomason, Encinitas, CA (US)

Correspondence Address: CISLO & THOMAS, LLP, 233 WILSHIRE BLVD, SUITE 900, SANTA MONICA, CA, 90401-1211, US

(21) Appl. No.: 11/399,572

(22) Filed: Apr. 6, 2006

Related U.S. Application Data
(60) Provisional application No. 60/702,359, filed on Jul. 25, 2005.
(60) Provisional application No. 60/728,135, filed on Oct. 18, 2005.

(51) Int. Cl. G09F 13/02

(52) U.S. Cl. 40/559

(57) ABSTRACT

A lighting system for a real estate sign comprises an elongated illumination arm, a light source, an attachment housing, a power supply, and means for removably attaching the attachment housing to a real estate sign. The light source is connected to one end of the illumination arm, and the power supply is connected to another end. The lighting system may further have a switch to interrupt and reestablish the electrical communication between the power supply and the light source. In a version of the invention, the illumination arm is articulable and may be bent to direct light from the light source toward the sign.

### CROSS-REFERENCES TO RELATED APPLICATIONS

This patent application claims the benefit of U.S. Provisional Patent Application Ser. No. 60/702,359, filed Jul. 25, 2005, for Light for Real Estate Sign, and U.S. Provisional Patent Application Ser. No. 60/728,135, filed Oct. 18, 2005, for Light for Real Estate Sign, which applications are incorporated here by this reference.

### TECHNICAL FIELD

This invention relates to lighting and display devices, and more particularly to a lighting system for a real estate sign.

### BACKGROUND ART

It is known in the selling and renting of real estate that proper signage should be strategically placed on the property. Common real estate practice includes using a real estate sign having a vertical post with a horizontal cross-arm to hang an advertising panel. However, such real estate signs are difficult to view after dark. In addition, it may be difficult to light such signs after dark because of an absence of a convenient power supply. Portability of the lighting system is also important, since the signs are repeatedly moved from one location to the next.

Accordingly, there is a need for a convenient, portable, and detachable lighting system for a real estate sign that provides its own source of lighting, is lightweight, and is easy to install and remove from the sign.

### DISCLOSURE OF INVENTION

In an embodiment of the invention, a lighting system for a real estate sign comprises an elongated illumination arm, a light source, and an attachment housing. The attachment housing further comprises a power supply and means for removably attaching the attachment housing to a real estate sign. The light source is connected to one end of the illumination arm, and the power supply is connected to another end.

The elongated illumination arm is cantilevered to the attachment housing. In this way, the light source is located at a distance from the face of the real estate sign's advertising panel sufficient for the emitted light to disperse to a majority of the advertising panel. This design permits a smaller bulb to illuminate more of the advertising panel than with other configurations. It further allows the advertising panel to remain illuminated when the sign is swaying from the wind.

In an embodiment of the invention, the means for removable attachment of the attachment housing to a real estate sign may be at least one pair of sliding members. At least one of the sliding members within the pair is slideably adjustable toward and away from the other sliding member in the pair to accommodate a variety of sign dimensions.

In a version of the invention, the illumination arm may be removably connected to the attachment housing to facilitate storage and transportation of the real estate sign light or allow for leaving the relatively inexpensive an unobtrusive attachment housing on the sign when the lighting is not needed. In addition, the detachable illumination arms could be moved from one attachment housing to another. This increases the flexibility of use and transport of the real estate sign light by permitting a first attachment housing to be left on one sign while the illumination arms are moved to a second sign where they are attached to a second attachment housing.

### BRIEF DESCRIPTION OF DRAWINGS

FIG. 1 is a perspective view of an embodiment of the invention mounted on a real estate sign.

FIG. 2 is an exploded view of an embodiment of a light source of a real estate sign light.

FIG. 3 is an exploded view of an embodiment of a real estate sign light.

FIG. 4 is a perspective view of the underside of an embodiment of the invention.

FIG. 5 is a perspective view of an embodiment of the invention mounted on a real estate sign and having multiple illumination arms for each face of the advertising panel.

FIG. 6 is a perspective view of an embodiment of the invention mounted on a real estate sign and having branched illumination arms.

FIG. 7 is a perspective view of an embodiment of the invention mounted on a real estate sign and having a single illumination arm.

FIG. 8 is a perspective view of an embodiment of the invention mounted on a real estate sign and having an elongated light source.

FIG. 9 is a perspective view of an embodiment of a light source of the invention having one aperture for an LED or light bulb.

FIG. 10 is a perspective view of an embodiment of a light source of the invention having more than one aperture for an LED or light bulb.

FIG. 11 is a side view of an additional embodiment of the invention mounted on a real estate sign.

FIG. 12 is a perspective view of an additional embodiment of the invention mounted on a real estate sign.

FIG. 13 is a perspective view of an additional embodiment of the invention mounted on a real estate sign.

FIG. 14 is an electrical schematic for an LED circuit board for an embodiment of the invention.

FIG. 15 is an electrical schematic showing connection of multiple LEDs for an embodiment of the invention.

### BEST MODE FOR CARRYING OUT THE INVENTION

The present invention is directed to a lighting system for real estate signs. The detailed description set forth below in connection with the appended drawings is intended as a description of the presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

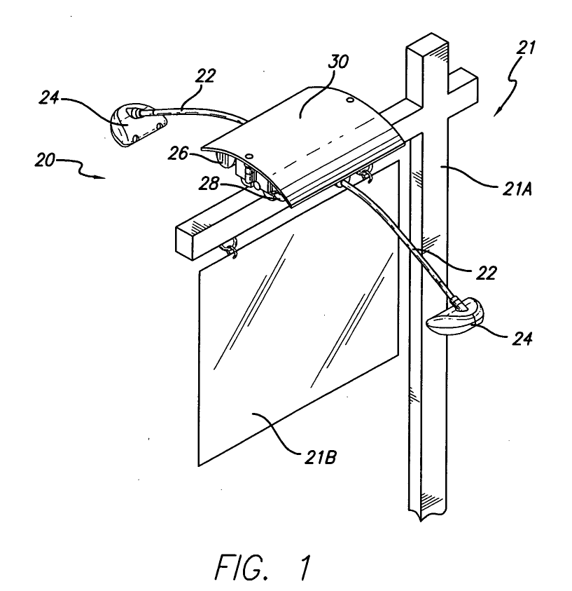

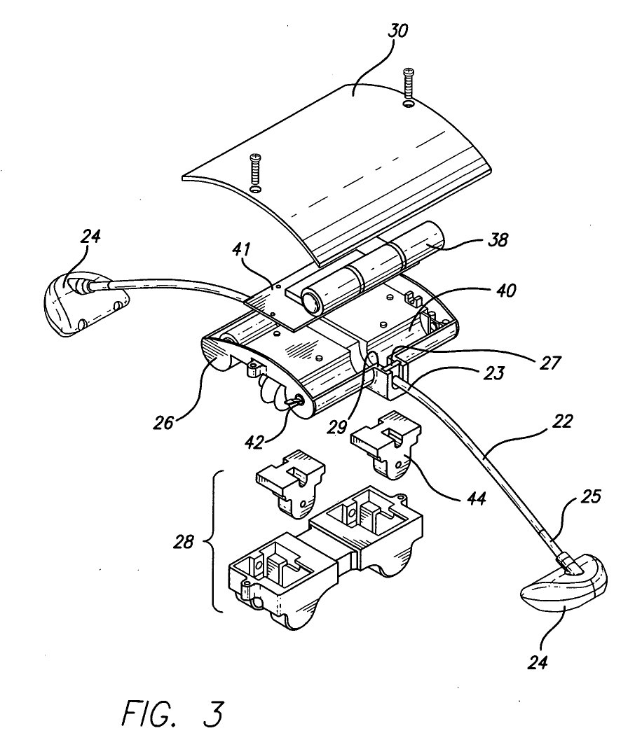

Referring to FIG. 1, a lighting system for a real estate sign 20 comprises an elongated illumination arm 22, a light source 24, and an attachment housing 26. The attachment housing 26 further comprises a power supply 38 (FIG. 3) and an attachment means 28 for removably attaching the attachment housing 26 to a real estate sign 21, including the sign post 21A and the sign's advertising panel 21B. The elongated illumination arm 22 has an attachment end 23 and a cantilevered end 25. The light source 24 is connected to the cantilevered end 25 of the illumination arm 22, and the attachment housing 26 is connected to the attachment end 23 such that the elongated illumination arm 22 extends outward from the attachment housing 26. The power supply 38 is in electrical communication with the light source 24, permitting the light source 24 to emit light. In a version of the invention, the electrical communication may be obtained by electrical wiring between the power supply 38 and the light source 24.

The attachment housing 26 may provide water resistance or weather resistance to the power supply 38. The attachment housing 26 may further comprise a protective cover 30 to provide additional weather resistance for the power supply 38. Although the attachment housing 26 may have any suitable dimensions, one embodiment is configured with a width of about 5.4 inches, a length of about 6.8 inches, and a height of about 2.0 inches. A gasket may be provided between the protective cover 30 and the remainder of the attachment housing 26 to help seal out the elements. In some embodiments, the protective cover 30 may be connected to the remainder of the attachment housing 26 in a water tight fashion, in a water resistant fashion, or in a weather resistant fashion.

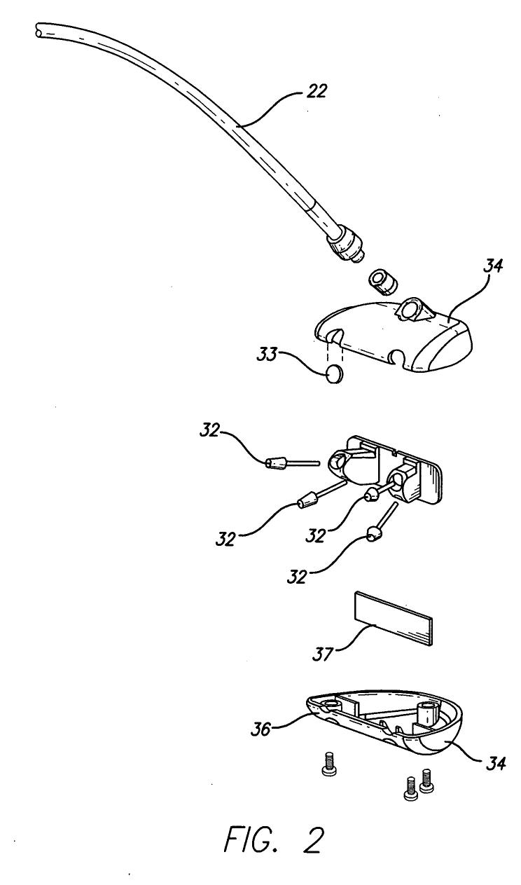

Referring to FIG. 2, in a version of the invention, the light source 24 may have at least one light emitting diode (LED) 32, and in some versions there may be a plurality of light emitting diodes 32. In other versions, the light source 24 may have at least one incandescent bulb (not depicted), fluorescent bulb (not depicted), or other luminous device. In some embodiments, the light source 24 may comprise a plurality of LED's 32 or light bulbs. In embodiments having a plurality of LED's 32 or light bulbs, the LED's 32 or light bulbs can be arrayed in a line, a regular geometric pattern such as is depicted in FIG. 2, or any other pattern to adequately illuminate the face of the advertising panel 21B of the sign 21.

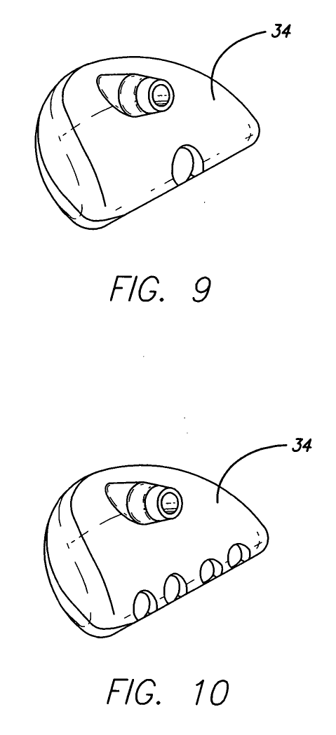

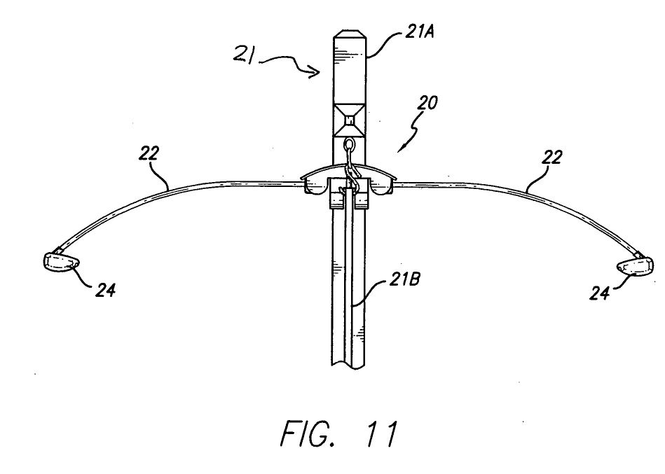

The light source 24 may further have a light housing 34. The light housing 34 may comprise a top portion and a bottom portion, configured to enclose an LED 32 between the portions, and which may be secured together with various fasteners, such as bolts, screws, or rivets. A portion of the bottom portion of the light housing 34 may be translucent, allowing light from the light source 24 to illuminate a sign 21. In another embodiment, the LED 32 may protrude from the bottom portion of the light housing 34 to illuminate the sign 21. In an embodiment, the light source 24 may further comprise at least one light dispersal element to facilitate distribution of the light emanating from the light source over the face of the advertising panel 21B. In some embodiments, the light dispersal element may be a prism, a reflective surface, a dispersive coating on the LED 32 or other light bulb, or at least one lens 33, one of which is depicted in FIG. 2. As depicted in FIG. 9, some embodiments of the light housing 34 may comprise a single opening to permit light to emanate; as depicted in FIG. 10, the light housing 34 may comprise multiple openings for the emanation of light.

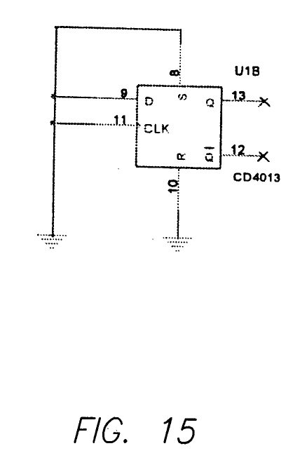

The light source 24 may further include an LED circuit board 37 to control the LED 32. A schematic of a version of the LED circuit board 37 is shown in FIG. 14. In the schematic depicted, the circuit board 37 is used to switch on the LED 32 by using a photo eye, or light regulated switch, when the eye detects darkness. In the embodiment shown, a timer on the circuit board 37 turns off the LED 32 after a selected amount of time. However, embodiments without a timer or using a different switch mechanism to turn off and on the light source 24 are equally contemplated, as discussed further below. A schematic showing how multiple LEDs could be connected is given in FIG. 15.

Although the light housing 34 may have any suitable dimensions, in one embodiment the light housing 34 may have a width of about 2.0 inches, a length of about 3.0 inches, and a height of about 0.5 inches, where the top plan profile of the light housing 34 is generally triangular. Further, the elongated illumination arm 22 may have a length of between about ten and thirty-six inches, more preferably between twelve and twenty-four inches, and most preferably about eighteen inches. In the preferred embodiment, the elongated illumination arm 22 may have a diameter of about 0.25 inches.

In addition, the light housing 34 may be water resistant and weather resistant to protect the light source 24. The light housing 34 may include a removable panel 36 secured by a screw or other fastening mechanism to provide access to the LED 32 or incandescent bulb for replacement purposes. In the embodiment depicted in FIG. 2, the removable panel 36 is the bottom portion of the light housing 34. The light housing 34 may be secured to the elongated illumination arm 22 by a threaded nut, a plug, an insert, or other suitable device.

As depicted in FIG. 3 the power supply 38 may comprise at least one battery. The attachment housing 26 may further have at least one arcuate receptacle 40 to receive the at least one battery, for example, an AA, C, or D battery. Preferably, six C batteries are used. The arcuate receptacle 40 may also be shaped to receive a battery pack or other suitable power supply (not depicted). The power supply 38 may further include a circuit board 41 to control the distribution of power to the light source 24.

In some embodiments, the power supply 38 may comprise a solar powered generator to convert light energy into electrical energy. In embodiments using solar energy, solar cells may be positioned on the attachment housing 26 or on the protective cover 30 to absorb sunlight or other ambient light. It is equally contemplated that some embodiments may comprise both a solar powered generator and at least one battery. In such embodiments, the solar generator may recharge the at least one battery, and in some embodiments the solar generator may prolong battery life by supplementing the battery's power. That supplementation might occur from the solar generator working simultaneously with the at least one battery, or it might occur from the solar generator operating as a backup to the at least one battery. Similarly, the at least one battery might act as the backup to the solar generator.

The lighting system 20 may further have a switch to interrupt and reestablish the electrical communication between the attachment housing 26 and the light source 24. In FIG. 3, the switch is depicted as a manual toggle switch 42. However, in some versions of the invention, the switch may be a timing device, where the electrical communication between the attachment housing 26 and the light source 24 is interrupted and reestablished at predetermined times. In some embodiments, the switch 42 may be a light sensor, or light regulated switch, for electrically interrupting and reestablishing the electrical communication between the attachment housing 26 and the light source 24 at predetermined levels of ambient light. The electronic controls for the timing device or the light sensor might be located in the circuit board 41 or in the LED circuit board 37 in some embodiments.

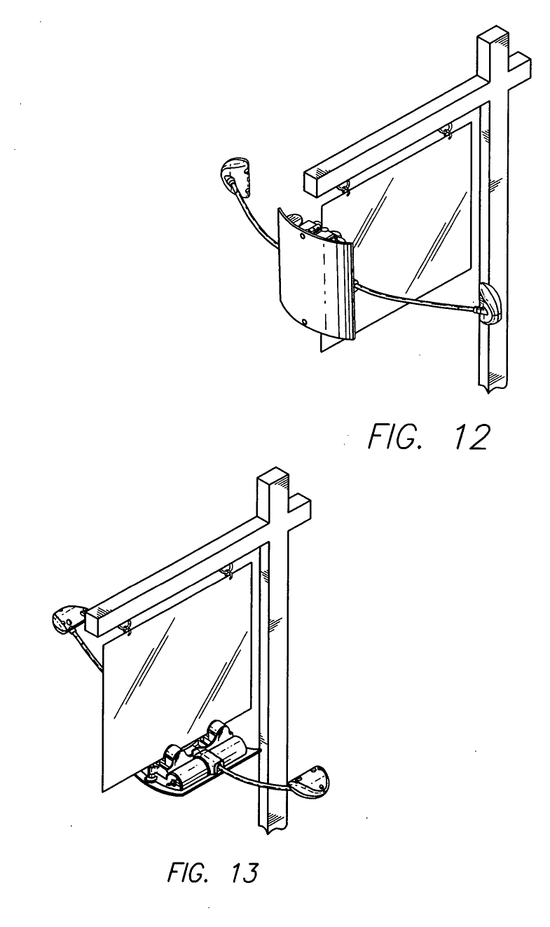

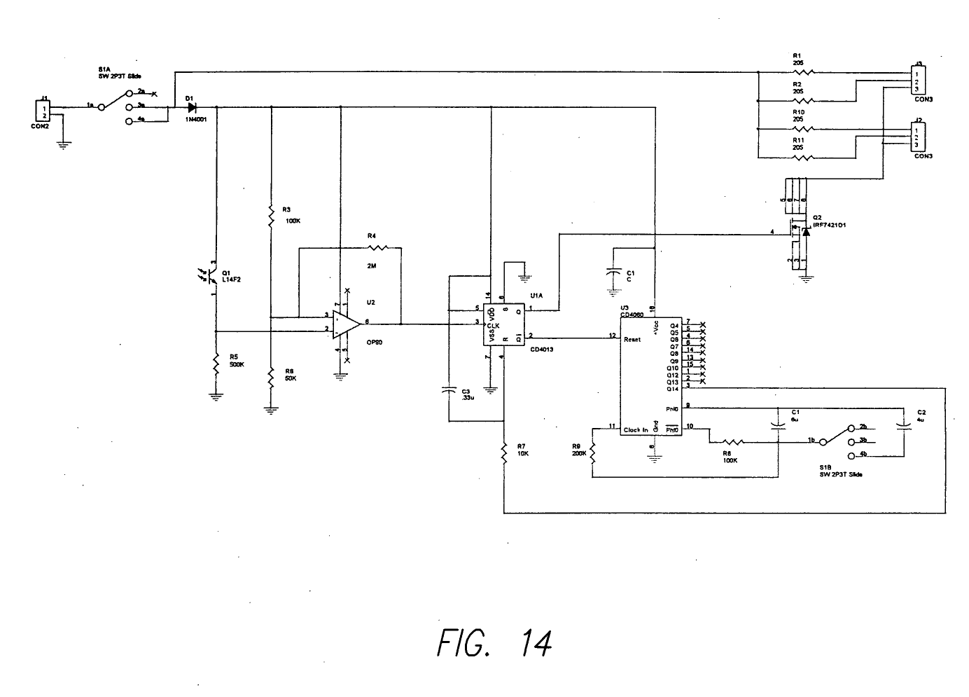

The simple mechanism to remove the attachment housing 26 from the real estate sign 21 provides for several features not found in the prior art. For example, the lighting system for a real estate sign 20 can be affixed to an existing sign without the need for drilling mounting holes into the sign post 21A or the advertising panel 21B or otherwise retrofitting a standard sign post or advertising panel so that the lighting system 20 can be attached. In addition, the lighting system for a real estate sign 20 can be easily moved from one real estate sign 21 to another, without the need to move the entire sign. As shown in FIG. 1, the lighting system 20 may be attached to the sign post 21A. In some embodiments, as depicted in FIGS. 11-13, the lighting system 20 may be attached to the advertising panel 21B of the real estate sign 21. In those embodiments, the lighting system 20 may be attached to the top edge, side edge, bottom edge, or other portion of the advertising panel 21B.

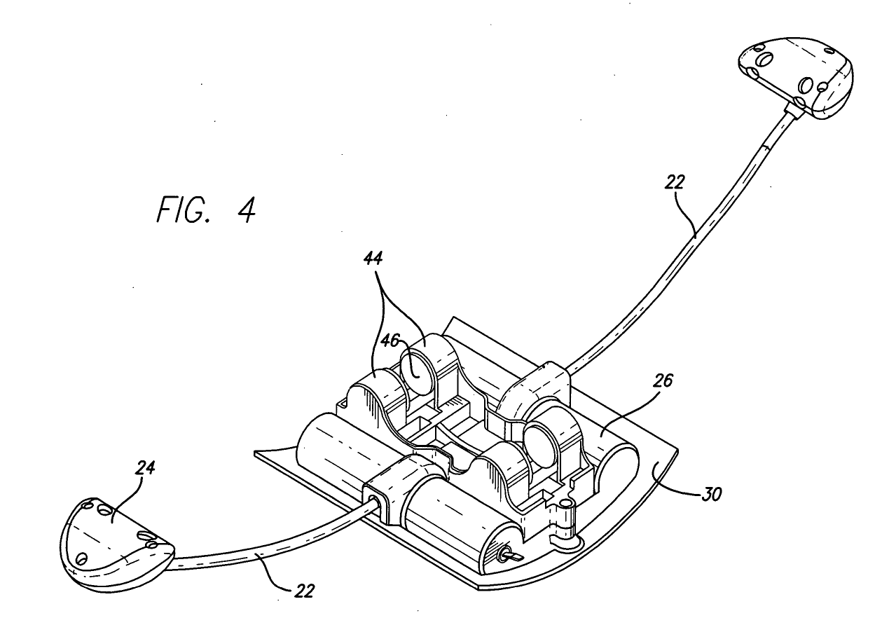

The attachment means 28 may be a gripping element, engagement element, holding clamp, clip, anchoring device, screw, bolt, adhesive, or some other connection mechanism. Referring to FIG. 3 and FIG. 4, the attachment means 28 may be at least one pair of sliding members 44. At least one of the sliding members 44 within the pair is slideably adjustable toward and away from the other sliding member in the pair. Further, the slideable adjustment defines a gap between the pair of sliding members 44 to accommodate a variety of sign 21 dimensions, including but not limited to those signs having one-quarter inch, one-half inch, and three-quarter inch bases. In some versions of the invention, the at least one pair of sliding members 44 clamps the real estate sign 21 in the gap between the pair of sliding members 44. Once adjusted for the dimensions of the sign, the sliding members 44 can be held in place by screws, clamps, bolts, or other conventional devices.

In some embodiments, the at least one pair of sliding members 44 further may have a grip member 46 to fasten the lighting system 20 to the sign 21. The grip members 46 may include hook and loop fasteners (e.g. VELCRO), springs, pressure pads, suction cups, bolts, screws, or other mechanisms for fastening the attachment housing 26 to the sign 21.

The elongated illumination arm 22 may be hollow to contain electrical wiring between the attachment housing 26 and the light source 24. The elongated illumination arm 22 further may be rigid, flexible, or moldable to various positions that are determined to provide lighting to the sign sufficient to make the sign visible in low ambient light conditions. For example, the elongated illumination arm 22 may have an articulable shaft or gooseneck that may be bent to direct light from the light source 24 toward the sign 21. The elongated illumination arm 22 may be removably connected to the attachment housing 26. A removably connected elongated illumination arm 22 may be removably inserted into holes or receptacles in the attachment housing 26. In the embodiment depicted in FIG. 3, the attachment end 23 of the elongated illumination arm 22 comprises an engaging member 27, such as a flange or a tongue, that snugly and stably fits into a mating slot 29 or a groove in the attachment housing 26 in an orientation to securely mount the elongated illumination arm 22 to the attachment housing 26 and bring the light source 24 into electrical communication with the power supply 38. In other embodiments, the removable connection may comprise a quick disconnect electrical connector of the type known in the art. A cover, plate, or plug may be provided for the holes or receptacles to provide a weather resistant cover should one or more of the elongated illumination arms 22 be removed from the attachment housing 26.

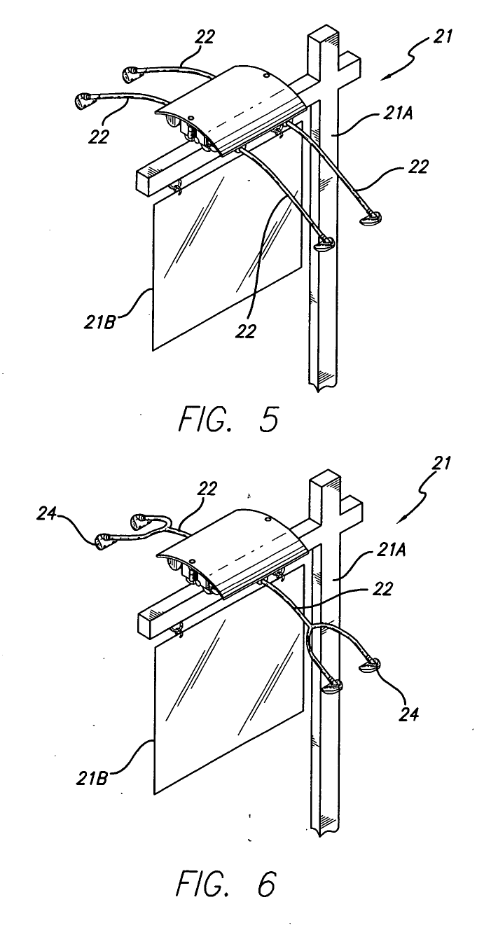

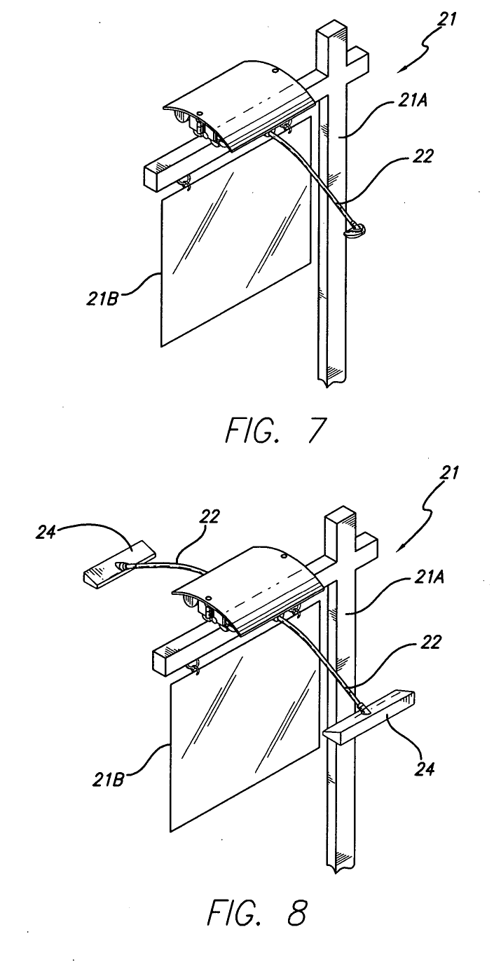

As shown in FIG. 5, there may be multiple elongated illumination arms 22 to light each face of the advertising panel 21B. As shown in FIG. 6, the elongated illumination arm 22 may be branched such that more than one stalk or appendage diverges from the attachment end 23. In some embodiments, there may be a light source 24 on one, more than one, or on each of the appendages. As shown in FIG. 7, there may be only a single elongated illumination arms 22. The light source 24 may be of various shapes, including triangular, round, elongated, or rectangular. Refer to FIG. 8, for example. In embodiments not having a light housing 34, the light source 24 may comprise only the LED or light bulb itself.

The elongated illumination arm 22, attachment housing 26, and light housing 34 may be made from injection molded plastic, sheet metal (such as tin, aluminum, galvanized steel, or stainless steel), thermoplastics, polycarbonates, natural or synthetic rubbers, and other suitable materials.

While the present invention has been described with regards to particular embodiments, it is recognized that additional variations of the present invention may be devised without departing from the inventive concept.

### INDUSTRIAL APPLICABILITY

This invention can be used to provide a lighting system for a display device. In particular, the invention can be used by a real estate agent to attach to and light a real estate sign.

What is claimed is:

1. A lighting system for a real estate sign having a plurality of sign faces, comprising:
(a) at least one elongated illumination arm having an attachment end and a cantilevered end;
(b) a light source connected to the cantilevered end of the illumination arm, comprising at least one light emitting diode;
(c) an attachment housing removably connected to the attachment end of the illumination arm, such that the cantilevered end of the illumination arm extends from the attachment housing;
(d) an engaging member on the attachment end of the illumination arm and a linking member on the attachment housing, where the engaging member and the linking member are dimensioned, shaped, and sized to securely mate;
(e) a power supply in electrical communication with the light source, the power supply being within the attachment housing such that the attachment housing provides weather resistance to the power supply; and
(f) an attachment mechanism to connect the attachment housing to a real estate sign comprising at least one pair of sliding members, wherein at least one of the members within the pair is slideably adjustable toward and away from the other member in the pair, and wherein the slideable adjustment defines a gap between the pair of sliding members such that the sliding members clamp the real estate sign in the gap between the members.

2. The lighting system of claim 1 wherein the light source further comprises at least one light dispersal element to distribute the light emanating from the light source.

3. The lighting system of claim 1 wherein the engaging member comprises a tongue and the linking member comprises a groove, where the tongue is dimensioned to fit securely into the groove.

4. The lighting system of claim 1 further comprising at least one elongated illumination arm to illuminate any portion or all of the plurality of sign faces.

5. The lighting system of claim 1 further comprising a light housing to provide weather resistance to the light source.

6. A lighting system for a real estate sign comprising:
(a) at least one elongated illumination arm having an attachment end and a cantilevered end, wherein the illumination arm is articulable;
(b) a light source connected to the cantilevered end of the illumination arm;
(c) an attachment housing removably connected to the attachment end of the illumination arm, such that the cantilevered end of the illumination arm extends from the attachment housing;
(d) a power supply in electrical communication with the light source, the power supply being within the attachment housing such that the attachment housing provides weather resistance to the power supply; and
(e) a holding clamp to connect the attachment housing to a real estate sign.

7. The lighting system of claim 6 wherein the light source further comprises at least one lens to disperse the light emanating from the light source.

8. The lighting system of claim 6 wherein the light source comprises at least one light emitting diode.

9. The lighting system of claim 6 further comprising a light-regulated switch to interrupt and reestablish the electrical communication between the power supply and the light source at predetermined levels of ambient light.

10. The lighting system of claim 6 further comprising a switch and a timing device, wherein the electrical communication between the power supply and the light source is connected and interrupted at predetermined times.

11. The lighting system of claim 6 wherein the holding clamp comprises at least one pair of bracing elements, wherein at least one of the bracing elements within the pair is movable toward and away from the other element in the pair, and wherein the movement defines a gap between the pair of bracing elements, such that the bracing elements firmly abut a real estate sign placed within the gap.

12. The lighting system of claim 6 further comprising a light housing to provide weather resistance to the light source.

13. A lighting system for a real estate sign having at least one sign face, comprising:
(a) at least one elongated arm having an attachment end and a cantilevered end;
(b) a luminous device connected to the cantilevered end of the elongated arm;
(c) an attachment housing removably connected to the attachment end of the elongated arm, such that the cantilevered end of the elongated arm extends from the attachment housing;
(d) a power supply in electrical communication with the luminous device, the power supply being within the attachment housing such that the attachment housing provides weather resistance to the power supply; and
(e) a sign engagement element for engaging the attachment housing with a real estate sign.

14. The lighting system of claim 13 wherein the luminous device further comprises at least one lens to disperse the light emanating from the luminous device.

15. The lighting system of claim 13 wherein the luminous device comprises at least one light emitting diode.

16. The lighting system of claim 13 wherein the removeable connection between the elongated arm and the attachment housing comprises an arm engaging member on the attachment end of the elongated arm and a linking member on the attachment housing, where the engaging member is dimensioned to securely mate with the linking member.

17. The lighting system of claim 16 wherein the arm engaging member comprises a flange and the linking member comprises a slot, where the flange is dimensioned to fit snugly and stably into the slot.

18. The lighting system of claim 13 further comprising a timer switch to interrupt and reestablish the electrical communication between the power supply and the luminous device.

19. The lighting system of claim 13 further comprising a light-sensor switch to interrupt and reestablish the electrical communication between the power supply and the luminous device.

20. The lighting system of claim 13 wherein the sign engagement element comprises at least one pair of sliding members, wherein at least one of the sliding members within the pair is slideably adjustable toward and away from the other sliding member in the pair, and wherein the slideable adjustment defines a gap between the pair of sliding members to accommodate a variety of sign dimensions.

21. The lighting system of claim 20 wherein the at least one pair of sliding members are brought together to hold the real estate sign between the pair of sliding members.

22. The lighting system of claim 13 wherein the elongated arm is rigid.

23. The lighting system of claim 13 wherein the elongated arm is moldable to a determined position.

24. The lighting system of claim 13 further comprising at least one elongated arm to illuminate each face of the sign.

25. The lighting system of claim 13 further comprising a light housing to provide weather resistance to the luminous device.

26. A lighting system for a real estate sign comprising:
(a) at least one extended arm having an attachment end and a cantilevered end;
(b) a light source connected to the cantilevered end of the extended arm;
(c) a power supply connected to the attachment end of the extended arm, wherein the power supply is in electrical communication with the light source, permitting the light source to emit light; and
(d) a gripping element to removably fasten the power supply to a real estate sign.

27. The lighting system of claim 26 wherein the extended arm is removably attached to the power supply.

28. The lighting system of claim 26 wherein the light source further comprises at least one lens to disperse the light emanating from the light source.

29. A lighting system for a real estate sign having at least one sign face, comprising:
(a) at least one lighting arm having an attachment end and a branched end, the branched end having at least two appendages diverging from the attachment end;
(b) a light-emitting device connected to at least one appendage of the branched end of the lighting arm;
(c) an attachment housing connected to the attachment end of the lighting arm, such that the branched end of the lighting arm extends from the attachment housing;
(d) a power supply in electrical communication with the light-emitting device, the power supply being within the attachment housing such that the attachment housing provides weather resistance to the power supply; and
(e) a connection mechanism to anchor the attachment housing to a real estate sign.

30. The lighting system of claim 29 further comprising a light-emitting device connected to each appendage of the branched end of the lighting arm.

31. The lighting system of claim 29 wherein the lighting arm is moldable to a determined position.

32. The lighting system of claim 29 wherein the light-emitting device comprises at least one light emitting diode.

33. The lighting system of claim 29 wherein the lighting arm is removably connected to the attachment housing.

34. The lighting system of claim 29 further comprising at least one lighting arm to illuminate each face of the sign.

35. The lighting system of claim 29 further comprising a light housing to provide weather resistance to the light-emitting device.
